(19) United States
(12) Patent Application Publication
(10) Pub. No.: US 2002/0183047 A1
(43) Pub. Date: Dec. 5, 2002

(54) Sensible information inquiry system and method for mobile phones

(75) Inventors: Ling Zhang, Shanghai (CN); Tony Tsai, Hsinchu (TW)

Correspondence Address: DOUGHERTY & TROXELL, SUITE 1404, 5205 LEESBURG PIKE, FALLS CHURCH, VA, 22041, US

(73) Assignee: Inventec Appliances Corp.

(21) Appl. No.: 09/871,625

(22) Filed: Jun. 4, 2001

(51) Int. Cl. H04M 3/42

(52) U.S. Cl. 455/414; 455/564

(57) ABSTRACT

A system and method for information inquiry to phone books or databases of mobile phones is disclosed. In one embodiment, the disclosed system integrates person names and company titles into keywords to find properly allocations in databases for storage purpose. An individual may inquire information by giving keywords under input modes by means of English characters, mandarin phonetic notations, or pinyin syllables for searching. A telephone number selected from the searched database records can then be dialed based on individual's selections.

### BACKGROUND OF THE INVENTION

1. Field of the Invention

The present invention relates to a system and method for sensibly inquiring information from mobile phones. More particularly, the present invention relates to a system and method for inquiring information from mobile phones by means of characters established from mandarin phonetic notations or pinyin syllables.

In a specific application, the present invention relates to a system and method that facilitates an individual to inquire information from mobile phone databases that includes a plurality of telephone numbers, while the individual dials a specific telephone number searched from the mobile phones.

2. Description of the Prior Art

Advancements in electrical engineering and communication networks allow the modern world to exhibit various appearances everyday. A manifest fact is that information in different formats or characteristics is derived and delivered more frequently than before. Also due to the prosperous developments of the modern technologies, the ways of telephony communications have made progress from delivering data by means of various fixed transference lines to wireless communications. Mobile phones or cellular phones are therefore become essentially portable devices for modern persons nowadays.

Conventional mobile phones are ordinarily incapability of registering Chinese or mandarin characters. An individual may inquire information from phone books of mobile phones by employing English characters firstly, then the mobile phone searches and fast locates associated cursor to the first record of the inquired phone book databases according to the input English characters. Finally an individual may select a telephone number stored in one inquired record for dialing later. Obviously, it is quite an inconvenient for an individual who is not skilled in English to inquire information from phone books of the conventional mobile phones. Furthermore, conventional phone books only consist of fields or entries for storing person names in accompanied with telephone numbers, which are usually classified or sorted by names. For the modern smart cards, which frequently possess more entries consisting of kinds of information, such few entries for storing information are insufficient for information inquiry. For example, an individual may inquire no telephone number by means of company or organization titles under the conventional inquiry approaches. Any person or company should possess more than one telephone numbers today due to the prosperity of the communication technologies. It is still impossible or difficult for an individual to search desire telephone numbers in the mobile phones by using Chinese characters via conventional approaches. There is need to disclose a novel information inquiry system and method for overcoming the aforementioned disadvantages when inquiring information from the phone books of the mobile phones conventionally.

### SUMMARY OF THE INVENTION

The principal object of the invention is the provision of a system and method employed for information inquiry from a phone book of a mobile phone by means of Chinese characters established by mandarin phonetic notations or pinyin syllables.

The other object of the invention is the provision of the system and method for information inquiry from a phone book of the mobile phone that possesses a plurality of telephone numbers for dialing according to selected one.

In one embodiment, an individual may give information concerned with person names in accompanied with company titles to search for proper allocations from phone book databases. Records in accompanied with index files of the databases are then properly modified. The given information may practically include a person name in accompanied with his or her company title, telephone numbers, and the relationship with the owner of the mobile phone. An individual may press buttons of his or her mobile phone under an input mode by means of English, mandarin phonetic notations or pinyin syllables to give keywords that are further converted according to currently employed input mode for information inquiry from phone book databases. Inquiry results are then shown to individual so that an individual may select a telephone number from the searched records for dialing.

In the embodiment, the disclosed system basically encompasses an input device, a display device, a processing device, and a database. Input device is used to receive commands or keywords from an individual, while the display device shows massages to the individual by means of optical signals. Processing device operates all operations of the disclosed system, such as interpreting commands or keywords from the individual, generating optical signals for the display device, accessing or inquiring information from the database. The database consists of tables for storing person names, company titles and telephone numbers, and software modules for storing programs operated by the processing device for input mode conversions and indexes modifications.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a schematic diagram of the embodiment according to the present invention;

FIG. 2 illustrates a mapping list for key value conversions in the embodiment;

FIG. 3 illustrates a flow diagram of the operating sequences for converting key values input from an individual according to a currently employed input mode;

FIG. 4 illustrates a flow diagram of the operating sequences when storing information input by an individual;

FIG. 5 illustrates a flow diagram of the operating sequences when an individual dials a specific telephone number selected from searched database records;

FIG. 6A illustrates an exemplary data list of the database table module;

FIG. 6B illustrates an exemplary diagram when an individual inquires information under the pinyin mode of the embodiment;

FIG. 6C illustrates an exemplary diagram when an individual inquires information under the phonetic mode of the embodiment; and

FIG. 6D illustrates an exemplary diagram when an individual selects one from the searched database records in FIGS. 6B or 6C.

### DESCRIPTION OF THE PREFERRED EMBODIMENT

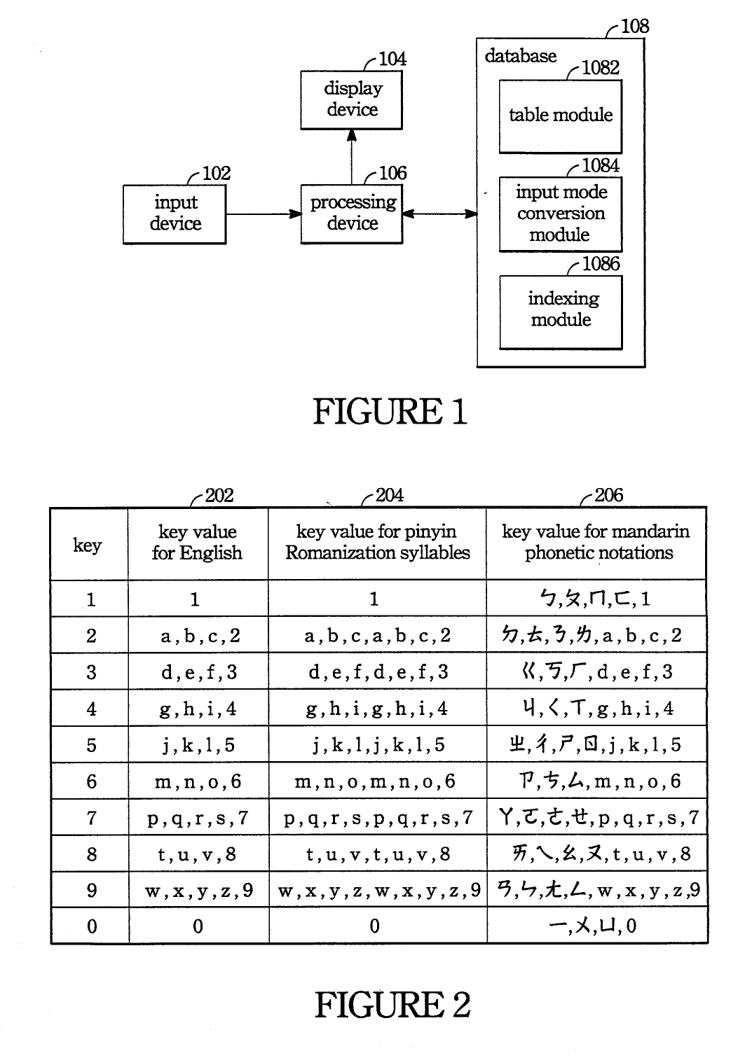

Please refer to FIG. 1 firstly, a schematic diagram of the disclosed system according to the preferred embodiment is shown therein, wherein the disclosed system in FIG. 1 basically encompasses input device 102, display device 104, processing device 106, and database 108. Input device 102 is used to receive commands or keywords from an individual, while display device 104 shows messages to the individual via optical signals. Processing device 106 performs required operations of the disclosed system, for example, the operations of interpreting commands or keywords from individual, displaying associated messages to individual via display device 104, and accessing/inquiring information from database 108. Database 108 stores telephone numbers, index files, and programs for input mode conversions and indexes modifications needed by the disclosed system. Additionally, database 108 further encompasses a table module 1082, an input mode conversion module 1084, and an index module 1086. Table module 1082 includes person names, company titles, telephone numbers, and relationships concerned with the owner of the mobile phone. Input mode conversion module 1084 stores programs operated by processing device 106 to perform input mode conversions, while indexing module 1086 includes index files offered aids for information inquiry according to individual's requirements.

Notably, input device 102 may be a conventionally employed keyboard, the display device may be a LCD, while the processing device 106 may be established by microprocessors mounted in mobile phones. Database 108 may be constructed in flash memory of the mobile phone. An ordinary person skilled in the art of the invention may modify the embodiment as specifications or applications but all the similar arrangements within the spirits of the embodiment should be included in the appended claims.

A keypad employed in a mobile phone conventionally is shown for explanations to the keywords given by using mandarin phonetic notations or pinyin syllables, wherein the former notifies original complex characters (Taiwan) and the latter notifies simplified Chinese characters (mainland China) or pinyin Cantonese characters. FIG. 2 shows a diagram illustrative of a mapping list for key value conversions in the embodiment. For example, columns 202, 204, and 206 in FIG. 2 respectively demonstrate key values input by means of English characters (English mode), pinyin syllables (pinyin mode), and mandarin phonetic (phonetic mode) notations for information inquiry, which are sequentially shown for selection after associated keys being continuously pressed. For example, phonetic notation “ [symbol] ” is firstly shown when key “1” is pressed by an individual, however, phonetic notations “ [symbol] ”, “ [symbol] ”, “ [symbol] ”, and number “1” will be consecutively shown for selections if key “1” is continuously pressed. Input mode conversions may be achieved by means of keys “*”0 or “#”, or even the left/right buttons of the mobile phone. However, the mounted input modes may be varied according to markets or divisions that the mobile phones are for sale, a skilled person should modify the embodiment based on practical requirements.

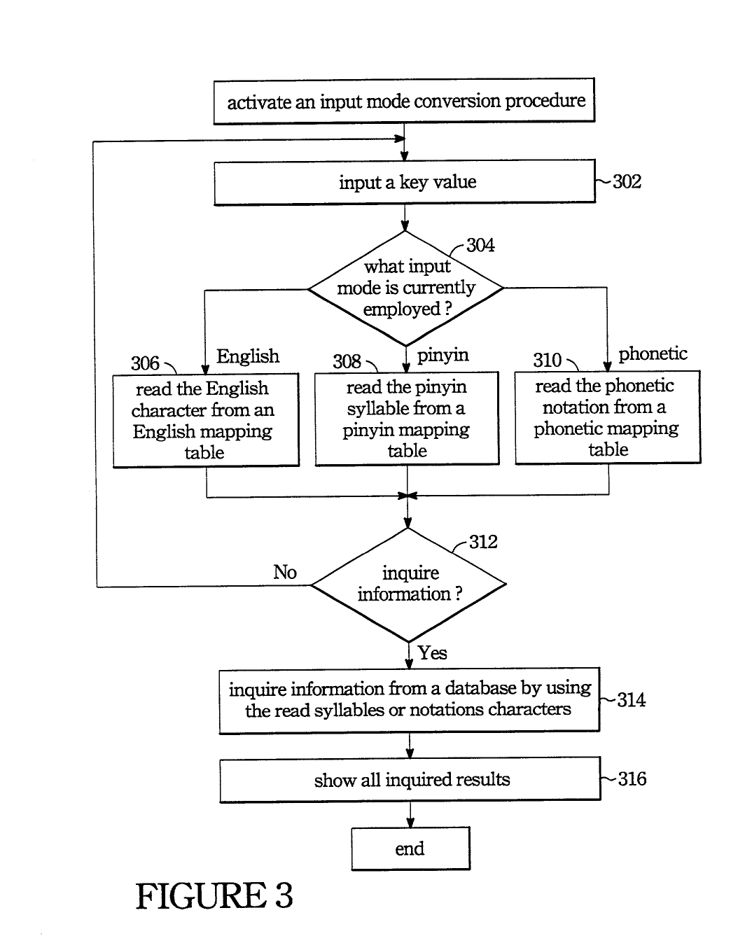

Please next refer to FIG. 3, a flowchart illustrative of the operating sequences for key value conversions according to the input mode selected by individual is shown therein. When an individual presses a key (step 302), the currently employed input mode is detected firstly (step 304). If the English mode is used currently, column 202 of FIG. 2 will be used for conversions to key value and obtain English character (step 306). If the pinyin mode is employed, column 204 of FIG. 2 is used for conversions to key value and obtains associated pinyin syllable (step 308). If the phonetic mode is employed currently, column 206 of FIG. 2 is used to convert key value to obtain associated mandarin phonetic notation (step 310). Next, if an individual confirm for searching (confirmation may be achieved by pressing the menu button, or the left/right button of the mobile phone as practical applications) (step 312), all input characters are then integrated into a keyword for inquiring information in the database 108 (step 314). All the inquired information is finally shown to the individual via the display device 104 (step 316).

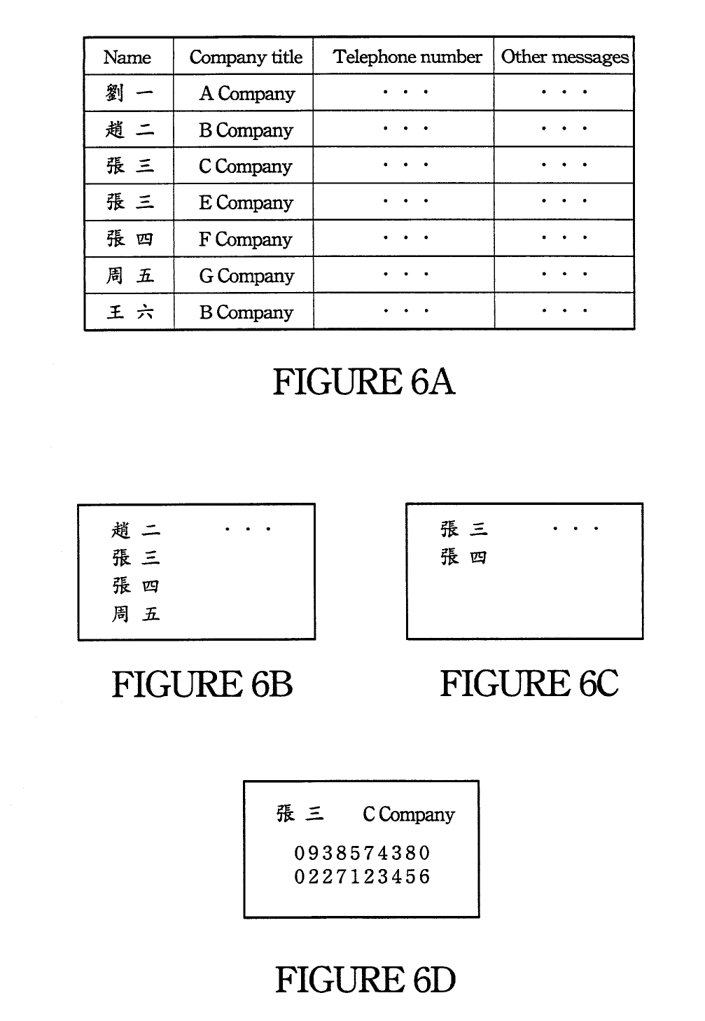

FIG. 6A depicts portions of table lists stored in the table module 1082 of database 108, for example, person names, company titles, telephone numbers, while FIGS. 6B and 6C show two examples when the pinyin mode or phonetic modes are employed, respectively. In practice, the diagram in FIG. 6B will be shown when an individual presses key “5” (because the first syllable is “j” under the pinyin mode) for inquiry. On the other hand, the diagram of FIG. 6C may be shown if the individual press key “5” to select “ [symbol] ” under the phonetic mode, and then presses key “9” to select “ [symbol] ” for information inquiry. Notably, the way of real-time inquiry may be employed in step 312 for showing all inquiry results according to currently input keyword. For example, all words leading with mandarin phonetic notation “ [symbol] ” can be shown to individual as depicted in FIG. 6B when he or she presses key “5” to select “ [symbol] ”. However, when an individual consecutively presses key “9” to select “ [symbol] ”, the diagram of FIG. 6C will be shown continuously. Any person skilled in the art of the present invention may modify the embodiment as specifications and requirements but all the similar arrangements and modifications within the spirits of the embodiment should be included in the appended claims.

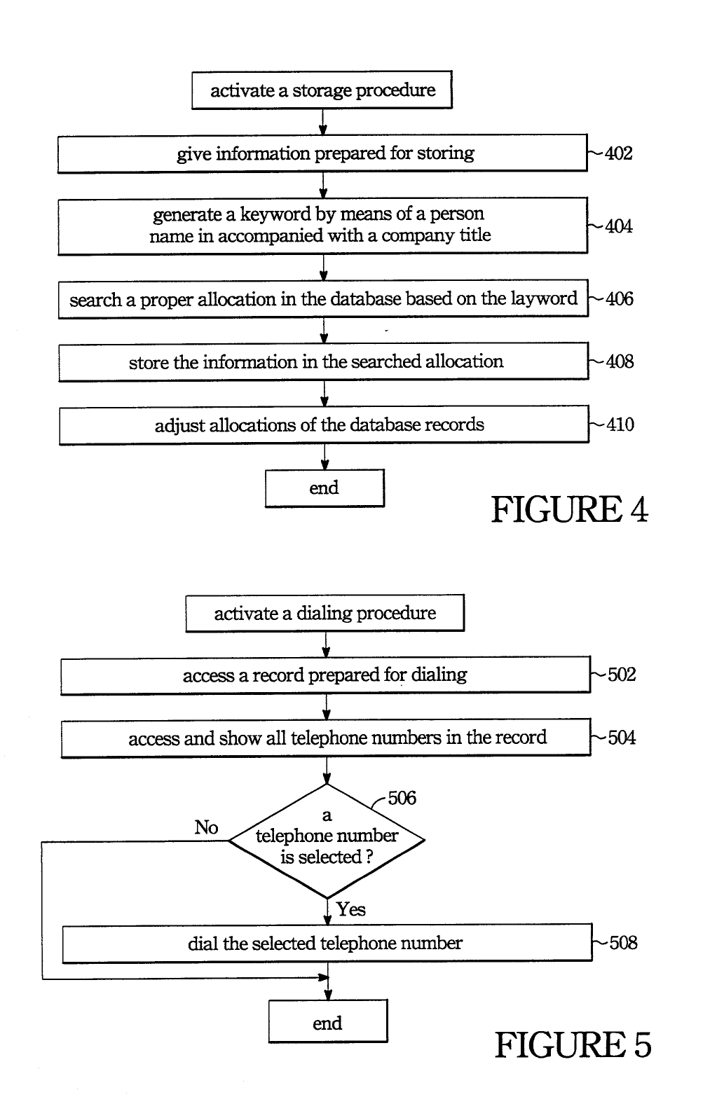

In the embodiment, database 108 integrates a person name in accompanied with his or her company title into a keyword for storage purpose. Therefore any individual may inquire information via key-pressings, while the inquiry information may be shown to individual after searching. The storage way of the embodiment is illustrated in the following paragraphs by means of the flowchart in FIG. 4. An individual may firstly offer information, which may consists of person names, company titles, telephone numbers, relationships between the person whose relative information being stored and the owner of the mobile phone, or the owner's nicknames (step 402). Each keyword is then derived in the disclosed system by integrating all converted key values into a keyword that indicates a person name in accompanied with his or her company title (step 404). A searching operation is then activated by the disclosed system to find a proper record in the database 108 by means of the generated keyword (step 406). The input information is finally stored in a new record of the database 108 (step 408) before adjusting or modifying the indexes relative to the new stored one (step 410) to complete whole the operating sequences.

For example, if an individual inputs a person name “ [symbol] ” and in accompanied with company title “D company”, the integrated keyword by means of “ [symbol] ” and “D company” will be derived in the disclosed system. Next, the disclosed system will find the allocation indicative of “ [symbol] ” and “C company” by employing the integrated keyword in step 406. The disclosed system then creates a new record to store the currently input information in step 408 and then adjusts indexes of database 108 (i.e., modifying indexes of the index file) in step 410. FIG. 6A depicts the contents after database 108 being adjusted. As noted, the flow of FIG. 4 may be employed when the integrated keyword only contains company title, while the stored information may be inquired by following the flow of FIG. 3. An individual may therefore inquire desire telephone numbers whatever a person name or a company title is given. Additionally, any conventional searching scheme, e.g., binary search, may be employed in the preferred embodiment for information inquiry, any ordinary person skilled in the art associated with the present invention may modify the embodiment according to requirements and specifications.

Please next refer to FIG. 5, a flowchart illustrative of the operating sequences when an individual dials the telephone number selected from the database records. When an individual selects a database record (step 502), the stored information of the selected record will be shown to individual (step 504). An individual then selects a telephone number from the shown records (step 506) for dialing in the following (step 508). For example, when an individual selects a person name “ [symbol] ” with company title “C company” as shown in FIGS. 6B and 6C, a diagram in FIG. 6D may be shown to individual to wait for further selections from those shown telephone numbers.

In conclusion, the disclosed system and method for sensibly inquiring information from phone books of mobile phones that integrates person names with company titles into keywords for searching proper allocations in databases for storage purpose. An individual may inquire information under input modes by means of English, mandarin phonetic notations, or pinyin syllables, while he or she may selects a telephone number from the searched records for dialing. An environment is given in the invention that provides interfaces or mechanism for information inquiry to telephone numbers by means of mandarin or Chinese characters.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An information inquiry method of a mobile phone comprising the steps of:
inputting a keyword;
converting said keyword according to an input mode currently employed by said mobile phone, said keyword being input according to an input mode by employing English characters, mandarin phonetic notations, or pinyin syllables;
searching information in a database of said mobile phone by using said converted keyword; and
showing searched information.

2. The information inquiry method according to claim 1, further comprising a step of switching said input mode currently employed to another input mode.

3. The information inquiry method according to claim 1, every record of said database comprising at least one telephone number.

4. The information inquiry method according to claim 3, further comprising a step of dialing a telephone number that is selected from said searched information from said database.

5. The information inquiry method according to claim 1, further comprising a method for storing a record into said database comprising the steps of:
inputting a telephone number and in accompanied with a name associated with said telephone number;
searching an allocation in said database by using said name; and
storing said telephone number and said name in said searched allocation.

6. The information inquiry method according to claim 5, said name comprising a person name or a company title.

7. A system for inquiring information from a mobile phone, said information inquiry system comprising:
a storage device for storing a database of said mobile phone and computer executable instructions; and
a processing device for operating said computer executable instructions to input a keyword;
convert said keyword according to an input mode currently employed by said mobile phone, said keyword being input according to an input mode by employing English characters, mandarin phonetic notations, or pinyin syllables;
inquire information from said database by using said converted keyword; and
display a record of said inquired information from said database.

8. The information inquiry system according to claim 7, said displayed record of said database comprising at least one telephone number.

9. The information inquiry system according to claim 8, said processing device operating said computer executable instructions to dial a telephone number that is selected from said record of said inquired information.

10. The information inquiry system according to claim 7, said processing device operating said computer executable instructions to
receive record information that comprises at least one name;
search an allocation from said database by using said telephone and said name; and
store said record information in said allocation.

11. The information inquiry system according to claim 10, said name comprising a person name or a company title.

12. The information inquiry system according to claim 7, said processing device operating said computer executable instructions to switch said input mode currently employed to another input mode.

13. A computer-readable storage medium for storing a method for inquiring information from a mobile phone, said computer-readable storage medium having computer executable instructions for performing steps comprising:
inputting a keyword;
converting said keyword according to an input mode currently employed by said mobile phone, wherein said input mode is used to input said keyword by employing English characters, mandarin phonetic notations, or pinyin syllables;
searching information in a database of said mobile phone by using said converted keyword; and
showing searched information.

14. The computer-readable storage medium according to claim 13, further comprising a step of switching said input mode currently employed to another input mode.

15. The computer-readable storage medium according to claim 13, every record of said database comprising at least one telephone number.

16. The computer-readable storage medium according to claim 15, further comprising a step of dialing a telephone number that is selected from said searched information from said database.

17. The computer-readable storage medium according to claim 13, further comprising a method for storing a record into said database comprising the steps of:
inputting a telephone number and in accompanied with a name associated with said telephone number;
searching an allocation in said database by using said name; and
storing said telephone number and said name in said searched allocation.

18. The computer-readable storage medium according to claim 17, said person name comprising a person name or a company title.
